(19) United States
(12) Patent Application Publication
(10) Pub. No.: US 2022/0270164 A1
(43) Pub. Date: Aug. 25, 2022

(54) Interface to Enable Integrating an Artificial Intelligence (AI) Order Taking System with Different Types of Point of Sale (POS) Terminals

(71) Applicant: ConverseNowAI, Austin, TX (US)

(72) Inventors: Pranav Nirmal Mehra, Bangalore (IN); Akshay Labh Kayastha, Karnataka (IN); Ruchi Bafna, Bengaluru (IN); Niyathi Allu, Tirupathi (IN); Sonali Dipsikha, Karnataka (IN); Anthony Lowe, Leander, TX (US); Vinayak T M, Bangaluru (IN); German Kurt Grin, Buenos Aires (AR); Wayne Moffet, Lake Worth, FL (US); Yuganeshan A J, Karnataka (IN); Vrajesh Navinchandra Sejpal, Bangalore (IN); Rahul Aggarwal, Austin, TX (US)

(21) Appl. No.: 17/688,877

(22) Filed: Mar. 7, 2022

Related U.S. Application Data
(63) Continuation-in-part of application No. 17/184,207, filed on Feb. 24, 2021.

(51) Int. Cl. G06Q 30/06; G06Q 20/20; G10L 15/06; G10L 15/02

(52) U.S. Cl. CPC G06Q 30/0641; G06Q 20/20; G10L 15/063; G10L 15/02; G10L 2015/0631

(57) ABSTRACT

In some examples, a server may receive, by a menu manager executing on the server, a menu having a particular format from a point-of-sale (POS) terminal and parse the menu to create a parsed menu. The menu is parsed using POS data indicating a formatting of the menu. The server automatically converts the parsed menu into multiple menu items, stores the multiple menu items in a menu item database, and creates a mapping database that includes pricing data, pronunciation data, and voice tags associated with individual menu items of the multiple menu items. The server provides multiple software agents access to the mapping database and instructs individual software agents of the one or more software agents to initiate a conversation with a customer to receive a voice-based order. The individual software agents comprise an instance of an artificial intelligence engine.

### CROSS-REFERENCE TO RELATED APPLICATIONS

The present patent application is a continuation-in-part of U.S. patent application Ser. No. 17/184,207, filed on Feb. 24, 2021, entitled “DETERMINING ORDER PREFERENCES AND ITEM RECOMMENDATIONS”, which is incorporated by reference herein in its entirety and for all purposes as if completely and fully set forth herein.

### BACKGROUND OF THE INVENTION

### Field of the Invention

This invention relates generally to systems to automatic speech recognition (ASR) system and, more particularly to providing

an interface to enable an ASR system to interface with different types of point of sale (POS) terminals.

### Description of the Related Art

Restaurants face many challenges. One challenge is to hire and retain employees. One way to reduce the number of employees is to enable ordering over voice channels (e.g., phone orders, drive through, and the like) by integrating an artificial intelligence (AI) based (e.g., voice-recognition) order taking platform with the restaurant's point-of-sale (POS) system. There are several challenges that may be encountered when deploying such a platform. A first challenge is that each restaurant (or restaurant chain) has their own particular menu that has to be adapted for voice ordering. A second challenge is that each restaurant (or restaurant chain) uses a particular type of point-of-sale (POS) terminal. For example, each type of POS terminal may have their own particular order management platform and middleware. This means that a provider of an AI-based order taking system has to customize each restaurant's menu to work with the AI-based order taking system and must manually implement menu changes, resulting in a lot of time and effort being constantly expended to keep the menu updated.

### SUMMARY OF THE INVENTION

This Summary provides a simplified form of concepts that are further described below in the Detailed Description. This Summary is not intended to identify key or essential features and should therefore not be used for determining or limiting the scope of the claimed subject matter.

In some examples, a server may receive, by a menu manager executing on the server, a menu having a particular format from a point-of-sale (POS) terminal and parse the menu to create a parsed menu. The menu is parsed using POS data indicating a formatting of the menu. The server automatically converts the parsed menu into multiple menu items, stores the multiple menu items in a menu item database, and creates a mapping database that includes pricing data, pronunciation data, and voice tags associated with individual menu items of the multiple menu items. The server provides multiple software agents access to the mapping database and instructs individual software agents of the one or more software agents to initiate a conversation with a customer to receive a voice-based order. The individual software agents comprise an instance of one or more artificial intelligence engines (e.g., implementing machine learning algorithms).

### BRIEF DESCRIPTION OF THE DRAWINGS

A more complete understanding of the present disclosure may be obtained by reference to the following Detailed Description when taken in conjunction with the accompanying Drawings. In the figures, the left-most digit(s) of a reference number identifies the figure in which the reference number first appears. The same reference numbers in different figures indicate similar or identical items.

FIG. 1 is a block diagram of a system that includes a server to host one or more artificial intelligence (AI) engines to engage in a conversation with a customer, according to some embodiments.

FIG. 2 is a block diagram of a natural language processing (NLP) pipeline, according to some embodiments.

FIG. 3 is a block diagram of a menu management system to interface with different types of point-of-sale terminals, according to some embodiments.

FIG. 4 is a block diagram of an exemplary user interface (UI), according to some embodiments.

FIG. 5 is a flowchart of a process that includes automatically generating a mapping database, according to some embodiments.

FIG. 6 is a flowchart of a process that includes storing a modified menu, according to some embodiments.

FIG. 7 illustrates an example configuration of a computing device that can be used to implement the systems and techniques described herein.

### DETAILED DESCRIPTION

U.S. patent application Ser. No. 17/184,207 describes a system in which a machine learning algorithm (e.g., an artificial intelligence (AI) engine) monitors a conversation between a customer and an employee at a restaurant. As the system is monitoring the conversation, the system interacts with a point-of-sale (POS) terminal to add, subtract, modify, or any combination thereof the contents of a cart. For example, if the customer is placing an order for one or more food items, the system may automatically (e.g., without human interaction) add contents to the cart based on the customer's voice input. To illustrate, if the customer says “Two large pepperoni pizzas” then the system automatically (e.g., without human interaction) adds two large pepperoni pizzas to the cart. Thus, the employee verbally interacts with the customer, without interacting with the point-of-sale terminal, and with the system interacting with the point-of-sale terminal. The employee observes the system modifying the contents of the cart while the employee is verbally interacting with the customer. The employee may interact with the point-of-sale terminal to make corrections if the system makes an error. The system may provide upsell recommendations to the employee to provide to the customer. The upsell recommendations may include increasing a size of an item ordered by the customer (e.g., “Would you like an extra-large instead of a large for just two dollars more?”, adding an item (e.g., “Would you like to add something to drink?”), or both. The upsell recommendations may be provided to the employee via, for example, audibly (e.g., via an earpiece) or visually (e.g., displayed on the point-of-sale terminal). In addition, the system may be used to train new employees by prompting them as to what to say to the customer during a conversation to take an order. The conversation data is collected and used to train the AI engine to enable the AI engine to interact with customers in a human-like conversation.

The systems and techniques described herein streamline ordering over voice channels (e.g., phone ordering, drive through, and the like) using a voice-based artificial intelligence (AI) platform that can be integrated with any point-of-sale (POS) terminal. Each restaurant (or restaurant chain) has a particular menu and a particular POS order management platform (e.g., Olo, Brink, or the like). The systems and techniques described herein enable seamless integration of the restaurant menu and the POS with a voice-based AI system (e.g., Converse Now AI). The systems and techniques provide a user interface (UI) to enable employees to easily import a menu to work with the voice-based AI system and to make changes to the menu (e.g., adding menu items, deleting menu items, modifying menu items, adding details about when a menu item is available, and the like).

The systems and techniques described herein enable a new POS to be quickly and easily integrated with a voice-based AI system. The systems and techniques described herein enable a new menu to be added or an existing menu to be easily modified. For example, a menu can be added or modified by an employee of the restaurant rather than a developer working for the voice-based AI system. The systems and techniques provide a single interface between different types of POS systems and the voice-based AI system without requiring changes to the voice-based AI system. The systems and techniques described herein automatically (e.g., without human interaction) import a menu and create a voice-enabled menu interface for use with the voice-based AI system. The systems and techniques described herein provide a UI to enable an employee to quickly and easily modify different characteristics of each menu item, such as voice tags, pronunciation, and the like to enable the voice menu to be modified for voice tags, pronunciation, and the like. A voice tag is a tag that can be used with a menu item and represents one way in a customer may reference the menu item. In some cases, each menu item may have multiple voice tags. For example, “cola”, “soda”, “pop”, and the like may be voice tags that reference a beverage, such as “Coke®”. In some cases, at least some of the voice tags may be regional. For example, people living in the northwest United States often use “pop” to reference a carbonated beverage. The systems and techniques enable the menu to be automatically (e.g., without human interaction) and regularly updated (e.g., at a periodic interval, such as every day, or in response to an update request).

A voice menu is different from an online (or other print-based) menu because the voice menu takes into account regional pronunciations, colloquial terms for a menu item, and the like. The AI system may internally use “mods” to refer to modifications to a menu item but for a pizza, the AI system may ask for “toppings”. A print menu may list beverages by “Size”, then “Flavor”, then “Beverage Item” while in a voice order, the expected voice flow may be “Item”, “Size”, and then “Flavor” to determine pricing. A print menu may list a “regular burger” and “double patty burger” as separate items but during a voice order, the AI system may ask “do you want double patties” during the customization flow when a customer orders “a burger”. The print menu may have salad dressing options (ranch, Italian, Thousand Islands etc.) for a salad while during a voice order the AI system may ask “what dressing would you like?” after a customer places an order for a salad. The print menu may include duplicated items, such as the same customization option duplicated under many items (e.g., beverage choices under each type of combo meal).

Thus, the systems and techniques described herein enable the voice-based AI system to seamlessly integrated with any 3rd party menu or order management platform (e.g., POS). The systems and techniques enable a menu from the POS to be easily converted into a menu for which voice-based orders can be received using the AI system. The systems and techniques enable dynamic synchronization of the POS and voice-based AI system. The systems and techniques provide a UI that is easy to use to enable restaurant employees to easily add a menu and modify the menu. Voice tags can be used across multiple menus and with POS platforms from different providers. Real-time synchronization of menu changes enables the menu to be easily modified for special promotions (e.g., seasonal promotions, celebrity promotions, and other types of limited availability promotions). The systems and techniques enable single item customization across multiple menu items. The systems and techniques provide an application programming interface (API) to enable the Menu from the POS system to be synchronized. After a menu has been imported from the POS system to the voice-based AI system, the imported menu is parsed and stored in a database (e.g., categories, menu items and their respective attributes, and the like. The menu stored in the database is sent to a menu mapping tool that provides a UI to change and update the details in the menu and supports setting up the menu based on how the voice-based AI system is setup. The menu mapping tool ensures that the menu structure is compliant with the POS synchronization API. In some cases, the menu mapping tool generates a yet another markup language (YAML) file that contains the menu with changes performed by the menu mapping tool. YAML is a human-readable data-serialization language. The menu mapping tool also takes into account nested menu items. For example, a meal combo may include two food items and a drink item. Each food item may include a type of pasta (spaghetti, fettuccini, macaroni, and the like) and a type of sauce (tomato, marinara, alfredo, and the like). For example, a combo order may include spaghetti with marinara (first food item), fettuccini with alfredo sauce (second food item), and a large cola (drink item).

As a first example, a method includes receiving, by a menu manager executing on a server, a menu having a particular format from a point-of-sale (POS) terminal and parsing the menu to create a parsed menu. The menu is parsed using POS data indicating a formatting of the menu to create a parsed menu. The parsed menu us automatically converted into multiple menu items that are stored in a menu item database. The menu manager creates a mapping database that includes pricing data, pronunciation data, and voice tags associated with individual menu items of the multiple menu items. The menu manager provides one or more software agents access to the mapping database and instructs individual software agents of the one or more software agents to initiate a conversation with a customer to receive a voice-based order. Each software agent is an instance of an artificial intelligence engine. The method may include receiving a customer utterance from the customer, determining, using the artificial intelligence engine, a customer intent based on the customer utterance, predicting, using the artificial intelligence engine, a menu item of the multiple menu items, and adding the menu item to an order associated with the customer. The method includes displaying a user interface to enable a user to modify the menu item database. The user interface automatically creates a checkpoint by storing a copy of the menu item database prior to the menu item database being modified. The checkpoint enables the copy of the menu item database to be restored in response to determining that an error occurred after modifying the menu item database. The user interface includes a search function to search for a particular menu item in the menu item database. The user interface includes an add interface element to add a new menu item to the menu, add one or more attributes associated with the new menu item, and add an availability of the new menu item. For example, the one or more attributes of the new menu item may include a display name associated with the new menu item for display by the point-of-sale terminal, a price associated with the new menu item, a description of the new menu item, one or more voice tags associated with the new menu item (e.g., each voice tag of the one or more voice tags identifies a vocalized word or phrase used to reference the new menu item, a preparation time to prepare the new menu item, an approximation of a number of people estimated to be served by the new menu item, or any combination thereof. The availability of the new menu item includes a start date indicating when the new menu item is available for ordering, an end date after which the new menu item is unavailable for ordering, a start time of day when the new menu item is available for ordering, an end time of day after which the new menu item is unavailable for ordering, or any combination thereof.

As a second example, a server includes one or more processors and one or more non-transitory computer readable media storing instructions executable by the one or more processors to perform various operations. The operations include receiving, by a menu manager executing on the server, a menu having a first format from a point-of-sale (POS) terminal and parsing, by the menu manager, the menu to create a parsed menu. The menu is parsed using POS data indicating a formatting of the menu. The operations include automatically converting the parsed menu into multiple menu items and storing the multiple menu items in a menu item database. The operations include creating a mapping database that includes pricing data, pronunciation data, and voice tags associated with individual menu items of the multiple menu items. The operations include providing multiple software agents access to the mapping database and instructing an individual software agent of the one or more software agents to initiate a conversation with a customer to receive a voice-based order. The individual software agents comprise an instance of an artificial intelligence engine. The operations may include receiving a second menu having a second format from a second point-of-sale (POS) terminal (e.g., provided by a different POS vendor than the first POS terminal). The second format is different from the first format. The operations include parsing, by the menu manager, the second menu to create a second parsed menu. The second menu is parsed using second POS data indicating a second formatting of the second menu. The operations include automatically converting the second parsed menu into additional menu items and storing the additional menu items in the menu item database. The operations include adding to the mapping database second pricing data, second pronunciation data, and second voice tags associated with individual ones of the additional menu items and providing the additional software agents access to the mapping database. The user interface includes displaying, at the point-of-sale terminal, a user interface (UI) to enable a user to modify the menu item database. The user interface automatically creates a checkpoint by storing a copy of the menu item database prior to the menu item database being modified. The checkpoint enables the copy of the menu item database to be restored in response to determining that a modification of the menu item database includes an error, and wherein the user interface includes a search function to search for a particular menu item in the menu item database. The user interface includes a modify interface element to modify a particular menu item currently in the menu, modify one or more attributes associated with the particular menu item, modify an availability of the particular menu item, or any combination thereof. The attributes of the particular menu item include a display name associated with the new menu item for display by the point-of-sale terminal, a price associated with the new menu item, a description of the new menu item, one or more voice tags associated with the new menu item (e.g., each voice tag of the one or more voice tags identifies a vocalized word or phrase used to reference the new menu item), a preparation time to prepare the new menu item, an approximate number of people estimated to be served by the new menu item, or any combination thereof. The availability of the particular menu item may include a start date when the particular menu item is available for ordering and an end date after which the particular menu item is unavailable for ordering. The availability of the particular menu item may include a start time of day when the particular menu item is available for ordering and an end time of day after which the particular menu item is unavailable for ordering.

As a third example, a memory device may store instructions executable by one or more processors to perform various operations. The operations include receiving, by a menu manager executing on a server, a menu having a particular format from a of point-of-sale (POS) terminal and parsing, by the menu manager, the menu to create a parsed menu. The menu is parsed using POS data indicating a formatting of the menu. The operations include automatically converting the parsed menu into multiple menu items and storing the multiple menu items in a menu item database. The operations include creating a mapping database that includes pricing data, pronunciation data, and voice tags associated with individual menu items of the multiple menu items. The operations include providing multiple software agents access to the mapping database and instructing individual software agents of the one or more software agents to initiate a conversation with a customer to receive a voice-based order. Each individual software agent comprises an instance of an artificial intelligence engine. The operations may include providing a user interface to enable a user to modify the menu item database. The user interface may automatically create a checkpoint by storing a copy of the menu item database prior to the menu item database being modified. In this way, the checkpoint enables the copy of the menu item database to be restored in response to determining that an error occurred after modifying the menu item database. The user interface may include a search function to search for a particular menu item in the menu item database. The user interface includes an add interface element to add a new menu item to the menu, add one or more attributes associated with the new menu item, and add an availability of the new menu item. The one or more attributes of the new menu item include a display name associated with the new menu item for display by the point-of-sale terminal, a price associated with the new menu item, a description of the new menu item, one or more voice tags associated with the new menu item, each voice tag of the one or more voice tags identifying a vocalized word or phrase used to reference the new menu item, a preparation time to prepare the new menu item, an approximation of a number of people estimated to be served by the new menu item, or any combination thereof. The availability of the new menu item may include a start date indicating when the new menu item is available for ordering and an end date after which the new menu item is unavailable for ordering. The availability of the new menu item may include a start time of day when the new menu item is available for ordering on each day of the week and an end time of day after which the new menu item is unavailable for ordering on each day of the week.

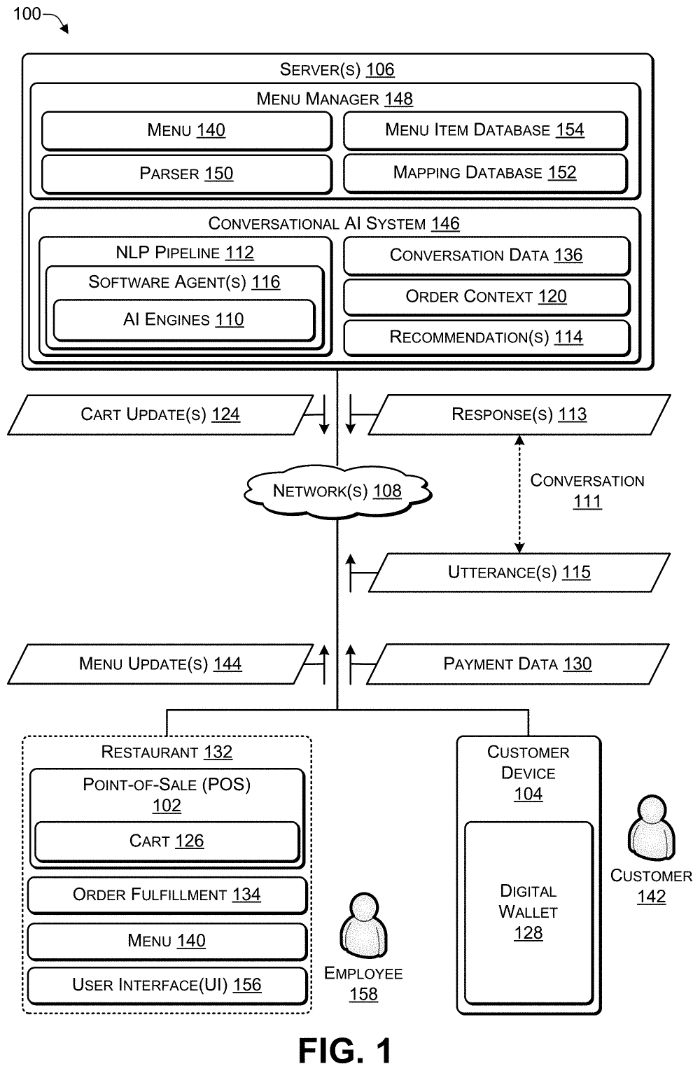

FIG. 1 is a block diagram of a system 100 that includes a server to host software, according to some embodiments. The system 100 includes a representative employee-assistance point-of-sale (POS) device 102, a customer device 104, and one or more server(s) 106 connected to each other via one or more network(s) 108. The server 106 may include an AI engine(s) 110 (e.g., a machine learning algorithm), a natural language processing (NLP) pipeline 112, and one or more software agents 116.

A customer 142 may use the customer device 104 to initiate an order to a commerce site, such as a restaurant 132. A restaurant is used merely as an example and it should be understood that the systems and techniques described herein can be used for other types of commerce, such as ordering groceries, ordering non-perishable items and the like. In some cases, a human employee may receive the order and the AI engine(s) 110 may monitor the conversation 111, including utterances 115 of the customer 142 and responses 113. The utterances 115 are the raw audio as uttered by the customer 142. Initially, the responses 113 may be from a human employee of the restaurant 132. The AI engine(s) 110 may determine which items from a menu 140 of the restaurant 132 the customer 142 is ordering. The AI engine(s) 110 may monitor the conversation 111 between the customer 142 and the employee and automatically (e.g., without human interaction) modify a cart 126 hosted by the POS device 102. In other cases, a human employee may receive the order, the AI engine(s) 110 may monitor the conversation between the customer 142 and the employee, and monitor what the employee enters into the POS device 102. The employee entries may be used as labels when training the AI engine(s) 110 and various machine learning (ML) models in the NLP pipeline 112. The AI engine(s) 110 may keep a running track of an order context 120 associated with each particular order. The order context 120 may include order data associated with previously placed orders by the customer 142, trending items in a region in which the customer 142 is located, specials/promotions (e.g., buy one get one free (BOGO), limited time specials, regional specials, and the like) that the restaurant 132 is currently promoting (e.g., on social media, television, and other advertising media), and other context-related information. The order context 120 may include user preferences, such as gluten allergy, vegan, vegetarian, or the like. The user may specify the preferences or the AI engines 110 may determine the preferences based on the customer's order history. For example, if the customer 142 orders gluten-free products more than once, then the AI engines 110 may determine that the customer 142 is gluten intolerant and add gluten intolerance to the customer's preference file. As another example, if the customer 142 orders vegan or vegetarian items (or customizes menu items to be vegan or vegetarian) then the AI engines 110 may determine that the customer 142 is vegan or vegetarian and add vegan or vegetarian to the customer's preference file. The cart 126 may include other information as how the order is to be fulfilled (e.g., pickup or delivery), customer address for delivery, customer contact information (e.g., email, phone number, etc.), and other customer information.

The customer 142 may use a payment means, such as a digital wallet 128, to provide payment data 130 to complete the order. In response, the restaurant 132 may initiate order fulfillment 134 that includes preparing the ordered items for take-out, delivery, or in-restaurant consumption. Such conversations between human employees and customers may be stored as conversation data 136. The conversation data 136 is used to train a software agent 116 to take orders from customers in a manner similar to a human employee, such that the customers may be unaware that they are interacting with the software agent 116 rather than a human employee.

Subsequently (e.g., after the software agent 116 has been trained using the conversation data 136), when the customer 142 uses a customer device 104 to initiate a communication to the restaurant 132 to place an order, the communication may be routed to the software agent 116. The customer 142 may have a conversation 111 that includes utterances 115 of the customer 142 and responses 113 by the software agent 116. In most cases, the conversation 111 does not include an employee of the restaurant. The conversation may be routed to a human being under particular exception conditions, such as due to an inability of the software agent 116 to complete the conversation 111 or the like.

The conversation 111 may include voice, text, touch input, or any combination thereof. For example, in some cases, the conversation 111 may include the voice of the customer 142 and the responses 113 of the software agent 116 may be vocalized (e.g., converted into a synthesized voice) using text-to-speech technology. The conversation 111 may include text input and/or touch input in which the customer 142 enters order information using a website, an application (“app”), a kiosk, or the like. One or more of the utterances 115 may result in the server 106 sending a cart update 124 to update a cart 126 at the point-of-sale device 102. The AI engine(s) 110 may determine (e.g., predict) recommendations 114 that the software agent 116 provides in the responses 113 as part of the conversation 111. For example, the recommendations 114 may be based on items that the customer 142 has previously ordered, items that are currently popular in the customer 142′s region (e.g., zip code, city, county, state, country, or the like), and the like. To determine items that the customer 142 previously ordered, the AI engine(s) 110 may determine an identity of the customer 142 based on, for example, an identifier (e.g., a phone number, an Internet protocol (IP) address, caller identifier, or the like) associated with the customer device 104, voice recognition, facial recognition (e.g., in the case of a video call), or another identifying characteristic associated with the order initiated by the customer device 104.

After the customer 142 has completed an order, the customer 142 may provide payment data 130, for example using an account (e.g., bank account, credit card account, debit card account, gift card account, or the like) stored in a digital wallet 128. The payment data 130 may be sent to the point-of-sale device 102 to complete a checkout process for the cart 126. After the payment data 130 has been received and the payment data processed, the restaurant 132 may initiate order fulfillment 134, such as preparing the items in the order for take-out, delivery, in-restaurant dining, or the like.

Thus, the system 100 includes an automated ordering system to enable customers to initiate and complete an order using voice, written text, or commands entered via a user interface (UI) provided by a website, an application (“app”) or the like. The system 100 is configured to enable the interactions between human customers and software agents 116 to be natural and human-like to such a degree that the human customers may conclude that they interacted with a human rather than a software agent. Thus, in so far as ordering food from a restaurant is concerned, the software agents 116 may pass the Turing test. The software agents 116 engage in human-like conversations in which the software agents 116 exhibit flexibility in the dialog. The software agents 116 are trained, based on the conversation data, to have an understanding of complex natural language utterances that take into account the nuances of oral and written communications, including both formal communications and informal communications. The term ‘utterance’ may include anything spoken or typed by a customer, including a word, a phrase, a sentence, or multiple sentences (including incomplete sentences that can be understood based on the context).

The system 100 includes a voice ordering system that takes the utterances 115 of a customer 142 and processes the utterances 115 through the Natural Language Processing (NLP) pipeline 112 (also referred to as a Natural Language Understanding (NLU) pipeline). The output of the NLP pipeline 112 are used by the server 106 to select: (1) a next one of the responses 113 that the software agent 116 provides the customer 142 in the conversation 111 and (2) the cart updates 124 to update the cart 126.

The systems and techniques described herein provide a data-driven approach to the NLP pipeline 112. The conversation data 136 includes hundreds of thousands of conversations between a human customer and a human employee and is used to train a supervised machine learning model (e.g., the software agents 116) to make the responses 113 of the software agents 116 as human-like as possible. The conversation data 136 includes human-to-human conversations used to train a domain specific language model (e.g., the software agents 116). The systems and techniques described herein take advantage of newly available language models that provide a greater capacity for leveraging contextual information over the utterances 115 (e.g., a word, a phrase, a sentence, or multiple sentences including incomplete sentences).

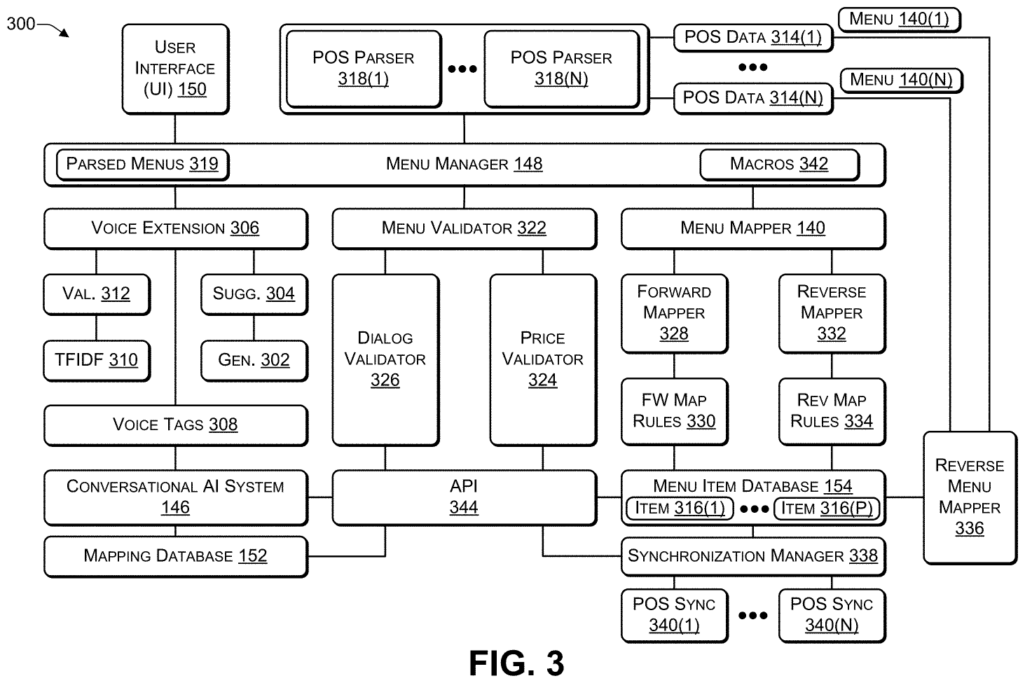

The server 106 hosts a menu manager 148 that is used to import a menu from different types of POS, such as importing the menu 140 from the POS 102. A parser 150 is used to parse the menu 140 to create a mapping database 152 (e.g., that maps the menu to menu items) and to create a menu item database 154 (e.g., that includes menu items and their relationships), as described in more detail in FIG. 3. The server 106 provides a user interface (UI) 156 to the POS 102 (or another computing device associated with the restaurant 132) to enable an employee 158 of the restaurant to upload the menu 140 to the server 106 to enable the menu 140 to be interfaced with the conversational AI system 146. The UI 156 also enables the employee 158 to add, delete, and modify menu items (e.g., breakfast menu items are available from 6:00 AM to 11:00 AM).

Thus, an AI engine may be used to listen in on conversations between customers and human employees. The AI engine may automatically (e.g., without human interaction) populate and modify a cart associated with an order that each customer is placing. The AI engine may automatically provide recommendations to the human employees on up-selling (e.g., adding items, increasing a size of ordered items, or both). The conversation data between customers and human employees may be stored to create a database of conversations associated with, for example, ordering food at a restaurant or another type of commerce site. The database of conversation data may be gathered over multiple months or years and used to train a machine learning algorithm, such as a software agent, to automatically take an order from a customer as if the customer was having a conversation with a restaurant employee. For example, given a conversation context and an utterance from the customer, the software agent determines and verbalizes (e.g., using text-to-speech) an appropriate and automated response using a natural language processing pipeline.

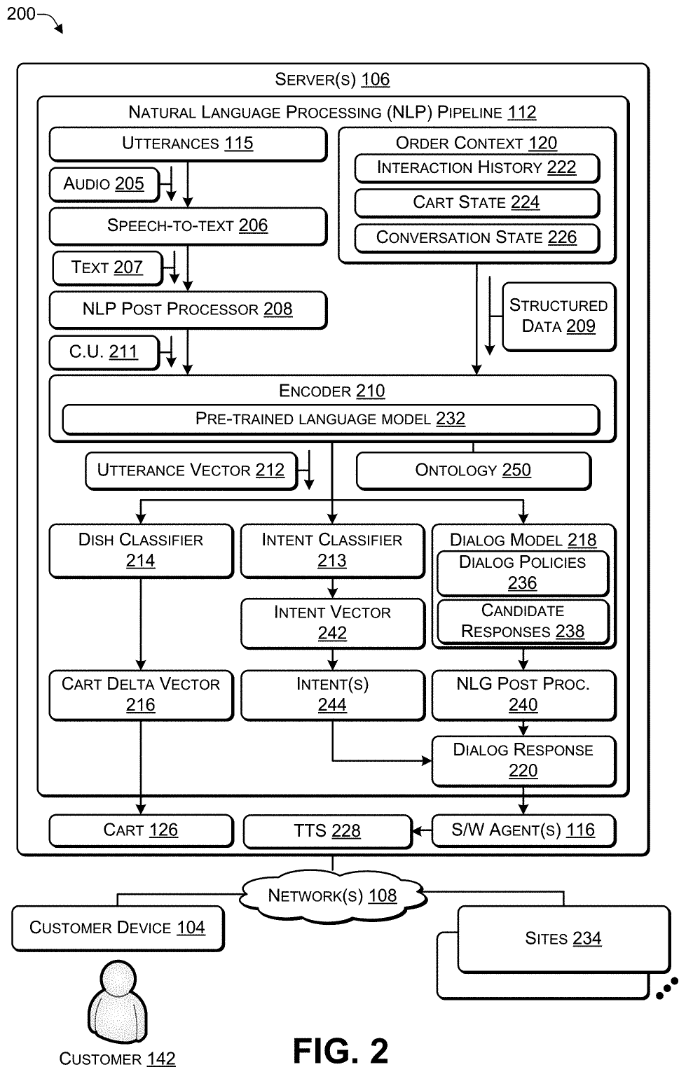

FIG. 2 is a block diagram 200 of the natural language processing (NLP) pipeline 112 of FIG. 1, according to some embodiments. The NLP pipeline 112 may receive the utterances 115 of the customer 142 (e.g., from the customer device 104 of FIG. 1). The NLP pipeline 112 may process audio data 205 that includes at least a portion of the utterances 115 using a speech-to-text 206 to convert the audio data 205 to text 207. For example, the utterances 115 may be “I would like 2 large pizzas with pepperoni and mushrooms.”

The order context 120 may include an interaction history 222 between the software agent 116 and the customer 142, a current cart state 224, and a conversation state 226. The interaction history 222 may include interactions between the customer 142 and one of the software agents 116, including the utterances 115 of the customer 142 and the responses 113 of the software agent 116. The cart state 224 identifies a state of the customer's cart including, for example, items in the cart, how many of each item is in the cart, a price associated with each item, a total price associated with the cart, whether payment has been received (e.g., whether the cart has been through check out), a most recent change (e.g., addition, subtraction, or modification) to one or more items in the cart, other cart related information, or any combination thereof. The conversation state 226 may indicate a state of the conversation between the customer 142 and the software agent 116, such as whether the conversation is in progress or has concluded, whether the customer 142 is asked a question and is waiting for a response from the software agent 116, whether the software agent 116 has asked a question and is waiting for a response from the customer 142, a most recent utterance from the customer 142, a most recent response from the software agent 116, other conversation related information, or any combination thereof.

The utterances 115 are provided by the customer 142 that has contacted the restaurant 132 of FIG. 1 to place an order. The utterances 115 are in the form of the audio data 205. The speech-to-text 206 converts the audio 205 into text 207. The text 207 is processed using an NLP post processor 208 that makes corrections, if applicable, to the text 207 to create corrected utterances 211. For example, the text 207 may include an incorrect word that is plausible in the context and multiple similar sounding words may be equally plausible. The NLP post processor 208 may make corrections by identifying and correcting one or more incorrect words in the text 207 to create corrected utterances 211. After the NLP post processor 208 processes the text 207, the corrected utterances 211 are sent to the encoder 210.

The order context 120, including the interaction history 222, the cart state 224, and the conversation state 226, are provided to the encoder 210 in the form of structured data 209. The structured data 209 includes defined data types that enable the structured data 209 to be easily searched. Unstructured data is raw text, such as “two pizzas with sausage and pepperoni”. Structured data may use a structured language, such as JavaScript Object Notation (JSON), Structured Query Language (SQL), or the like to represent the data. For example, “two pizzas with sausage and pepperoni” may be represented using structured data as: {“Quantity”: 2, “Item”: “Pizza”, “Modifiers”: [“Pepperoni”, “Sausage”]}. In structured data 209, each data item has an identifier or some fixed structured meaning and is not subject to natural language meaning or interpretation. The order context 120 captures where the customer 142 and the software agent 116 are in the conversation 111 (e.g., what has already been said), what items are in the cart 126, and the like.

The encoder 210 of the NLP pipeline 112 receives the text 207 (in the form of the corrected utterances 211) and the structured data 209 as input and predicts an utterance vector 212. For example, the encoder 210 may use word2vec, a two-layer neural net, to process the text 207 to create the utterance vector 212. The input to the NLP pipeline 112 is a text corpus and the output is a set of vectors, e.g., feature vectors that represent words in that corpus. The encoder 210 thus converts the text 207 into a numerical form that deep neural networks can understand. The encoder 210 looks for transitional probabilities between states, e.g., the likelihood that two states will co-occur. The NLP pipeline 112 groups vectors of similar words together in vector space to identify similarities mathematically. The vectors are distributed numerical representations of features, such as menu items. Given enough data, usage, and contexts during training, the encoder 210 is able to make highly accurate predictions about a word's meaning based on past appearances. The predictions can be used to establish the word's association with other words (e.g., “man” is to “boy” what “woman” is to “girl”), or cluster utterances and classify them by topic. The clusters may form the basis of search, sentiment analysis, and recommendations. The output of the encoder 210 is a vocabulary in which each item has a vector attached to it, which can be fed into a deep-learning net or simply queried to detect relationships between words. For example, by using cosine as a similarity measure, no similarity is expressed as a 90-degree angle, while total similarity is a 0-degree angle, complete overlap.

The encoder 210 may include a pre-trained language model 232 that predicts, based on the most recent utterances 115 and the current order context 120, (1) how the cart 126 is to be modified and (2) what the software agent 116 provides as a response, e.g., dialog response 220. The encoder 210 is a type of machine learning model for NLP that is a model pre-trained directly from a domain specific corpora. In some cases, the encoder 210 may use a Bidirectional Encoder Representations from Transformers (BERT), e.g., a transformer-based machine learning technique for natural language processing (NLP), to predict the utterance vector 212. The encoder 210 may be a language model 232 that converts the text 207 of the utterances into a vector of numbers. The language model 232 may be fine-tuned to a specific domain, e.g., to ordering at a restaurant and that too, at a specific type of restaurant (e.g., pizza, wings, tacos, etc.). The training is based on the conversation data 136 that has been gathered over time between customers and employees who enter data in the POS 102. The employee entered data may be used as labels for the conversation data 136 when training the various machine learning models described herein. The language model 232 associates a specific utterance, e.g., “I want chicken wings”, with a specific action, e.g., entering a chicken wing order into the POS 102. The language model 232 predicts what items from the menu 140 are to be added to the cart 126 (e.g., based on one or more actions associated with the utterance 115) and which items are to be removed from the cart 126, quantities, modifiers, or other special treatments (e.g., preparation instructions such as “rare”, “medium”, “well done” or the like for cooking meat) associated with the items that are to be added and/or removed. In some aspects, the encoder 210 may be implemented as a multi-label classifier. Modifiers may include, for example, half pepperoni, half sausage, double cheese, and the like. In some cases, the language model 232 may be structured hierarchically, e.g., with pizza at a high level and modifiers at a lower level. Alternately, the language model 232 may use a flat system with every possible combination as a unique item.

The utterance vector 212 may be used by three classifiers (e.g., a type of machine learning algorithm, such as a support vector machine or the like), including the dish classifier, the intent classifier 213, and the dialog model 218. For example, the utterance vector 212 may be used by the dish classifier 214 to predict a multiclass cart delta vector 216. The multiclass cart delta vector 216 is used to modify the cart 126. For example, in the cart delta vector 216, the first position may indicate a size of the pizza, e.g., 1=small, 2=medium, 3=large, the second position may indicate a type of sauce, e.g., 0=no sauce, 1=1st type of sauce, 2=2nd type of sauce, the third position may indicate an amount of cheese, e.g., 0=no cheese, 1=normal cheese, 2=extra cheese, 3=double cheese, and the remaining positions may indicate the presence (e.g., 1) or the absence (e.g., 0) of various toppings, e.g., pepperoni, mushrooms, onions, sausage, bacon, olives, green peppers, pineapple, and hot peppers. Thus, (3, 1, 1, 1, 0, 0, 0, 0, 0, 0, 0, 0) is a vector representation of a large pizza with the first type of sauce, a normal amount of cheese, and pepperoni. If the utterances 115 includes “I'd like double cheese”, then the vector representation may change to (3, 1, 3, 1, 0, 0, 0, 0, 0, 0, 0, 0), resulting in a corresponding change to the cart 126. Of course, this is merely an example and other vector representations may be created based on the number of options the restaurant offers for pizza size, types of sauces, amount of cheese, toppings, and the like.

The encoder 210 outputs the utterance vector 212 which a dialog model 218 uses to determine a predicted dialog response 220. For example, based on the order context 120 and the most recent utterances 115, the encoder 210 may determine the predicted response 220. The predicted response 220 is a prediction as to what a human employee would say at that point in the conversation (e.g., order context 120) based on the customer's most recent utterances 115. The encoder 210 is trained using the conversation data 136 to predict the dialog response 220 based on the utterances 115 and the order context 120. The software agent 116 converts the predicted dialog response 220 to speech using a text-to-speech converter 228. The dialog model may use dialog policies 236, candidate responses 238, and the order context 120 to predict the dialog response 220. For example, if the customer 142 states that they would like to order a burger, an appropriate response may be “what toppings would you like on that burger?” In some cases, a natural language generation (NLG) post processor 240 may modify the output of the dialog model 218 to create the dialog response 220. For example, the NLG post processor 240 may modify the dialog response 220 to include local colloquialisms, more informal and less formal dialog, and the like. The NLG response is the translation of the dialog response 220 into natural language.

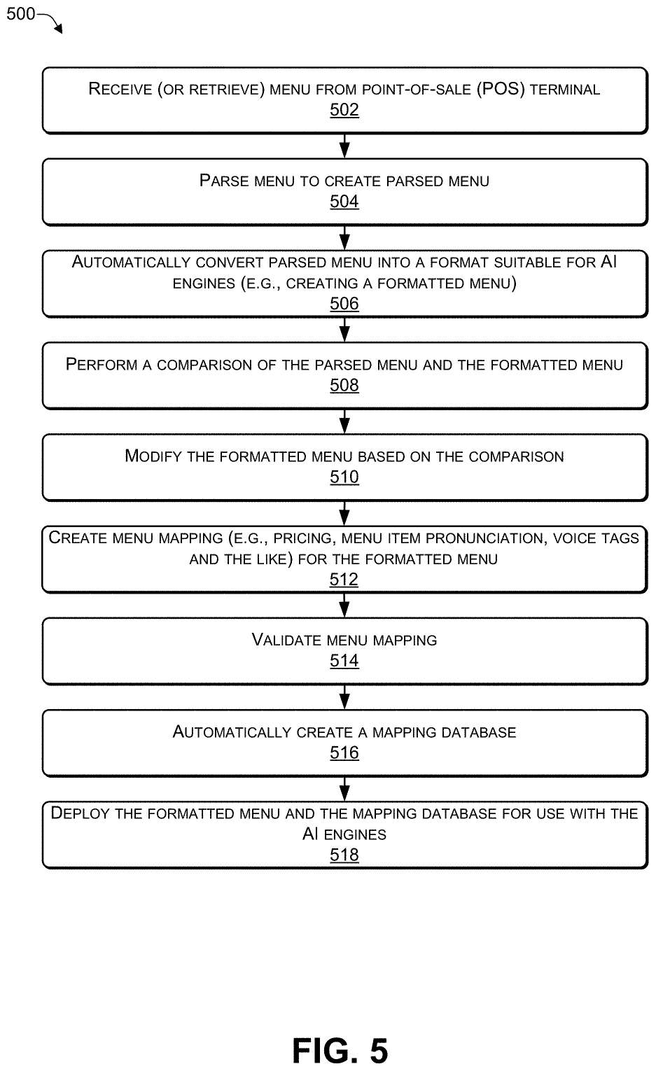

During training of the machine learning model used to create the software agents 116, the human-to-human conversations in the conversation data 136 of FIG. 1 are labelled to fine tune the language model 232, as described in more detail in FIG. 5. The utterances 115 and the order context 120 (e.g., contextual language information and current cart information up to a given point time) are encoded (e.g., into the utterance vector 212) to provide the cart delta vector 216 (e.g., a delta relative to the cart 126) as well as the next predicted dialog response 220. The cart delta vector 216 identifies the steps to update the cart 126. The codified delta over the cart indicates the steps to update the cart 126 and is the label that the human operator creates when handling the conversation that afterwards becomes the training dataset. For example, the encoder 210 is able to associate a specific utterance of the utterances 115, such as “I want chicken wings”, with a specific action, e.g., entering a chicken wing order into the cart 126. The encoder 210 predicts what items should be added to the cart 126 (e.g., based on the action associated with the utterance) and which items should be removed from the cart 126, and any associated quantities. In some aspects, the encoder 210 may use a multi-label classifier, such as for example, decision trees, k-nearest neighbors, neural networks, or the like. In a multi-label classifier, modifiers may include, for example, half-pepperoni, half-sausage, double cheese, and the like. In some cases, the order may use hierarchical structures, with each particular type of order, such as pizza, wings, taco, or the like, at a highest level and modifiers at a lower level in the hierarchy. For example, pizza may be at the highest level while half-pepperoni, half-sausage, double cheese, and the like may be at a lower level. In other cases, the order may use a flat system with every possible combination as a unique item. For example, (a) half-pepperoni may be a first item, (b) half-sausage may be a second item, (c) double cheese may be a third item, (d) half-pepperoni and half-sausage may be a fourth item, (e) half-pepperoni, half-sausage, and double cheese may be a fifth item, and so on.

The intent classifier 213 takes the utterance vector 212 as input and creates an intent vector 242 that represents intent(s) 244 of the utterances 115. Thus, the intent classifier 213 creates the intent vector 242 that is a representation of the customer's intent in the utterances 115. The intent vector 242, along with the utterance vector 212, is used by the dialog model 218 to determine the dialog response 220. The dialog model 218 uses the utterance vector 212 and the intents 244 to create the dialog response 220. The dialog model 218 predicts the dialog response 220, the response that the software agent 116 to the utterance 115. In contrast, in a conventional voice-response system, the system uses a finite state machine. For example, in a conventional system, after each utterance, the system may ask for a confirmation “Did you say ‘combo meal’? In the system of FIG. 2, a predictive model predicts the dialog response 220 based on the utterance 115 and the order context 120.

The dish classifier 214 predicts which items from the menu 140 the customer 142 is ordering and modifies the cart 126 accordingly. For example, in the utterance “Can I have 2 pizzas with pepperoni, 6 chicken wings, but no salad”, the dish classifier 214 determines which parts of this utterance refers to pizza. The dish classifier 214 model understands the history, e.g., there is a salad already in the cart (e.g., because it is included with chicken wings), and predicts the cart delta vector 216 to reflect how many pizzas and how many wings are there in the cart 126. The prediction of the dish classifier 214 indicates what is being added to and what is being deleted from the cart 126. Thus, based on the utterances 115 and the order context 120, the NLP pipeline 112 predicts the cart 126 and the dialog response 220. One or more of the classifiers 213, 214, 218 may use multiclass classification, a type of support vector machine. The intent classifier 213 determines intent(s) 244 of the utterances 115, e.g., is the intent 244 a menu-related question (e.g., “What toppings are on a Supreme pizza?” or a modification (“I'd link a large pepperoni pizza”) to the cart 126.

In some aspects, the menu 140 of the restaurant 132 of FIG. 1 may be represented as an ontology 250 (e.g., a set of menu items in the menu 140 that shows each menu item's properties and the relationships between menu items). In some aspects, the ontology 250 may be represented in the form of a vector. e.g., each type of pizza may have a corresponding vector representation. In some aspects, the menu representations may be generated from unlabeled data, to enable the NLP pipeline 112 to handle any type of information related to ordering, dishes, and food items.

The utterances 115 are used as input to the NLP pipeline 112. The utterances 115 may be in the form of a concatenated string of a set of previous utterances. The amount of utterances 115 provided to the NLP pipeline 112 may be based on how much latent knowledge of the conversation state 226 is desired to be maintained. The greater the amount of utterances 115, the better the conversation state 226. The utterances 115 may be a word, a phrase, a sentence, or multiple sentences (including incomplete sentences) that the customer 142 provides to the software agent 116 at each turn in the conversation. For example, an example conversation may include:
<agent> “Welcome to XYZ, how can I help you?”
<customer> “I'd like to order a large pepperoni pizza.”
<agent> “Got it. We have a promotion going on right now where you can get an extra-large for just two dollars more. Would you be interested in getting an extra-large?” (end of turn 1)
<customer> “Okay, give me an extra-large pepperoni.”
<agent> “Got it. Would you like anything to drink?” (end of turn 2)
<customer> “Two bottles of water please.”
<agent> “Got it. Anything else I can get for you? Dessert perhaps?” (end of turn 3)
<customer> “No. That will do it.”
<agent> “Did you want this delivered or will you be picking up?” (end of turn 4)
<customer> “Pickup.”
<agent> “Got it. Your total is $20.12. Our address for pickup is 123 Main Street. How would you like to pay?” (end of turn 5)
<customer> “Here is my credit card information <info>.”
<agent> “Thanks. Your order will be ready in 20 minutes at 123 Main Street.” (end of turn 6)

In this conversation, the customer may be initiating the order from home, may be at a drive-through, or may be talking to an automated (e.g., unmanned) kiosk in the restaurant. There are a total of 6 turns in this example conversation, starting with “I'd like to order a large pepperoni pizza”, with each turn including the customer's utterances 115 and the agent's response 220. The utterances 115 may thus include multiple sentences. In some aspects, chunking splitting may be performed, resulting in more than one representation corresponding to a unique utterance from the user. In some cases, the audio of the utterances 115 may be used as input, providing complementary features for emotion recognition, estimation of willingness to talk to AI, or for tackling issues as sidebar conversations. The satisfaction estimation based on vocal features also serves as a signal for optimizing the dialog policy.

The interaction history 222 includes contextual language information, such as, for example, the N previous utterances of the customer (N>0), the M previous responses from the software agent 116 (M>0). The cart state 224 includes current cart information. In some cases, a domain specific ontology 250 may be added as semantic representation of items in the knowledge base (e.g., the conversation data 136). The ontology 250 allows the encoder 210 to identify specific entities with which to select the correct modification to operate on the cart 126. The ontology 250 may be used to facilitate the onboarding of new items or whole semantic fields, alleviate the need for annotated data for each label (e.g., the entries of the employee into the POS 102), and improve the performance of the NLP pipeline 112.

The encoder 210 creates the cart delta vector 216 that includes corresponding actions to update the cart 126 based on the most recent (e.g., latest turn) of the utterances 115. The cart delta vector 216 may be a vector, e.g., a sparse array of numbers that corresponds to a state difference. For example, for a cart that includes “Large Pepperoni Pizza”, “2 Liter Coke” and “Chicken Salad”, if the most recent utterance is “A large coke, but remove the salad”, then the encoder 210 may output [0, 1, −1]. In this way, both the quantity and the intent to remove are encompassed.

The encoder 210 determines the utterance vector 212, a numerical representation of each input (e.g., the utterances 115 and the order context 120) based on the language model 232. The utterance vector 212 is a type of encoding, e.g., a set of symbols that represent a particular entity. For example, in some aspects, the encoding may be an array of real numbers, a vector (or a higher dimensional extension, such as a tensor), that is generated by a statistical language model from a large corpus of data. In addition to using the conversation data 136, the encoder 210 may leverage an additional corpus of data on multiple sites 234 (e.g., Wikipedia and the like), such as food-related sites, thereby enabling the encoder 210 to engage in specialized conversations, such as food-related conversations. In some cases, the encoder 210 may be trained to engage in conversations associated with a particular type of restaurant, e.g., a pizza restaurant, a chicken wings restaurant, a Mexican restaurant, an Italian restaurant, an Indian restaurant, a Middle Eastern restaurant, or the like.

The dish classifier 214 may predict the cart delta vector 216 by passing the encoded representations in the utterance vector 212 through additional neural dialog layers for classification, resulting in a sparse vector that indicates the corresponding element(s) within all possible cart actions, e.g., a comprehensive array of labels of possible combinations. The classifiers 213, 214, 218 may be trained using the conversation data 136. The ontology 250 provides information to precise the modifiers, relating cart actions that are highly related such as adding two different variations of the same dish.

The utterances 115 (e.g., representations of the conversation 111 of FIG. 1), along with the order context 120, may be used as the input to the encoder 210 to determine a particular one of the dialog policies 236 to select the next predicted response 220 of the software agent 116. Each particular one of the dialog policies 236 may be used to predict an appropriate response 220 from multiple candidate responses 238. In some cases, the dialog model 218 may use policy optimization with features such as emotion recognition, total conversation duration, or naturalness terms. The dialog response 220 may be fed back to the dialog model 218 as contextual information. In some cases, multitask learning algorithms that combine more than one similar task to achieve better results may be used with the encoder 210 to enable the encoder 210 to learn important aspects of language modeling that serve indirectly to the final downstream task, while allowing a controlled training process via the design of the learning curriculum. The multiple and auxiliary objective functions serve to leverage more error signals during training, and make the model learn proper representations of the elements involved. Semantic and structural information about the menu 140 is encoded into the ontology 250 and used to inform the later layers of the cart prediction system (e.g., dish classifier 214).

In some cases, curriculum learning may be used to design the order with which tasks of different types or complexity are fed to the encoder 210, the dish classifier 214, the intent classifier 213, the dialog model 218, or any combination thereof, to assist tackling different tasks or to perform prolonged training. In addition, to improve extended training processes, the systems and techniques described here may use continual learning, in which the encoder 210, the dish classifier 214, the intent classifier 213, the dialog model 218, or any combination thereof, are retrained as new conversation data is accumulated. In some cases, the continual learning may be performed with elastic weight consolidation to modulate optimization parameters. For example, continual learning along with incremental learning may be used for new classes, e.g., new dishes, sequentially adding them to the objective though training the same model. Curriculum learning is the process of ordering the training data and tasks using logic to increase the improvement on the later, objective tasks. For example, the first training may include auto-regressive loss, then sentence classification, and then a more complex task. In this way, the model may be incrementally improved instead of tackling directly a possibly too complex task. One or more of the machine learning models (e.g., 210, 213, 214, 218) in the NLP pipeline 112 may be re-trained using newly gathered conversation data 136. For example, the retraining may be performed to improve an accuracy of the machine learning models, to train the models for additional products (e.g., a pizza restaurant adds chicken wings) or additional services (e.g., a pandemic causes the introduction of curbside service as a variation of takeout). The retraining may be performed periodically (to improve accuracy) or in response to the introduction of a new product or a new service.

FIG. 3 is a block diagram of a menu management system 300 to interface with different types of point-of-sale terminals, according to some embodiments. The menu management system 300 is hosted by the server(s) 106 of FIGS. 1 and 2. In FIG. 3, N (where N>0) represents a number of different types of point-of-sale terminals (e.g., Brink, OLO, and the like).

An automatic tag generator 302 generates one or more voice tags for each menu item in the menus 140(1) to 140(N). A tag suggestions module 304 selects from the generated voice tags and provides them to a voice extension module 306 which selects voice tags 308 for use by the conversational AI system 146. For example, the tag suggestions module 304 may select from the generated voice tags based at least in part on the conversation data 136 of FIG. 1 that has been gathered over a period of time. To illustrate, the tag suggestions module 304 may select voice tags for a particular menu item based on the conversation data 136 that includes different ways in which customers have referenced each particular menu item. TFIDF module 310 provides a term frequency—inverse document frequency weighting that identifies how important a voice tag is to a menu item. The value of the TFIDF weighting increases proportionally to the number of times a voice tag appears in the conversation data 136 and is offset by the number of conversations in the conversation data that contain the voice tag, which helps to adjust for the fact that some voice tags are more frequently used than others. For example, voice tags for “iced tea” determined by the automatic tag generator 302 may include “iced tea”, “tea”, “cold tea”, “tea with ice”, “iced beverage”, and so on, with each voice tag receiving a TFIDF weighting. The tag suggestions module 304 may select particular voice tags from the voice tags generated by the automatic tag generator 302 based on each voice tag's TFIDF weighting. A tag validator 308 may determine whether each voice tag is valid based at least in part on the previously gathered conversation data 136 of FIG. 1. The voice tags 308 are provided to the conversational AI system 146 and to the voice extension module 306. The voice extension module 306 works with the menu manager 148 to tag each menu item with one or more voice tags 308. For example, most restaurants are supplied by either a first beverage provider (e.g., Coke®) or a second beverage provider (e.g., Pepsi®). Thus, at a restaurant supplied by the second beverage company, a customer request for “Coke®” is mapped to a menu item for “Pepsi®”, a customer request for “Sprite®” is mapped to a menu item for “SevenUp®” and so on. In this way, a “Pepsi®” menu item may have voice tags that include “Pepsi®”, “Pepsi® cola” (e.g., variations on how the product is referenced), “Coke®” (e.g., competing product), “cola” (e.g., generic term), and the like. Similarly, a “SevenUp®” menu item may have voice tags that include “SevenUp®”, “can of SevenUp®”, “Sprite®” (competing product), “lemon-lime drink” (generic term), and the like. Thus, a menu item may be tagged with voice tags associated with how customers reference a particular product, with voice tags for how customers reference a similar or a competitor's product, e.g., “Pepsi®”, and with voice tags for how customers reference a generic product, e.g., “cola”, as well as any other word or phrase that customers may use to reference the menu item. In this way, the conversation AI system is able to understand which menu item a customer is referencing even when the customer is not precise in identifying the menu item and uses a colloquial term for the menu item is referenced, uses a term for a competing product, or uses a term for a generic product.

POS data 314(1) includes data associated with how a 1st vendor's POS organizes and stores a menu and POS data 314(N) includes data associated with an Nth vendor's POS organizes and stores a menu. Each vendor's POS data 314 is used to create a POS specific parser to parse a menu stored in each vendor's POS. For example, POS parser 318(1) may use the POS data 314(1) to parse the menu 140(1) (e.g., stored in a 1st vendor's POS) and POS parser 318(N) may use the POS data 314(N) to parse the menu 140(N) (e.g., stored in an Nth vendor's POS) to create parsed menus 319.

The menu manager 148 uses a menu validator 322 that uses a dialog validator 326 to validate a dialog (e.g., pronunciations) of each menu item and uses a price validator 324 to validate a price (e.g., price pronunciations) of each menu item.

The menu mapper 140 uses a forward mapper 328 along with forward mapping rules 330 to perform forward mapping of menu items 316(1) to 316(P) (P>0) in the menu item database 154. The menu mapper 140 uses a reverse mapper 332 and reverse mapping rules 334 to perform reverse mapping of menu items 316 in the menu item database 154. A reverse menu mapper 336 uses the menus 140(1) to 140(N) to perform reverse menu mapping of menu items 316 in the menu item database 154.

A synchronization manager 338 uses POS specific synchronization (“sync.”) data, e.g., POS sync. data 340(1) associated with a POS from a 1st vendor and POS sync. data 340(N) associated with a POS from an Nth vendor to synchronize the menu manager 148 when the employee 158 of FIG. 1 makes changes to the menu. The changes may include adding a menu item to the menu, deleting a menu item from the menu, and modifying a menu item that is currently in the menu. Modifying a menu item may include modifying items included in a combo, modifying a price of the menu item, modifying when the menu item is available (e.g., breakfast items that were available between 6:00 AM and 11:00 AM are now available during regular business hours, such as 6:00 AM to 11:00 PM, a menu item that was previously available during a particular season is now available all the time, and the like).

The POS data 314 includes the rules associated with each POS. Predefined transformation macros 342 may be used to convert a menu stored in a POS into a menu that can be stored in the menu item database 154 and accessed by the conversational AI system 146. The menu manager 148 provides the ability to define new macros. The menu mapper 140 automatically creates the menu item database 154 based on a menu uploaded from a POS. The synchronization manager 338 provides automatic synchronization between a menu in a POS and the menu item database 154. For example, updates made to the menu at the end of day may be uploaded and propagated into the menu item database 154 to enable the conversational AI system 146 to take orders for the updated menu. In addition, the synchronization manager 338 enables menu updates to be pushed to the menu item database 154. For example, if a particular menu item goes out of stock during normal operating hours, the synchronization manager 338 can be used to indicate to the conversational AI system 146 that the particular menu item is unavailable and enable the system to suggest alternatives. For example, the conversational AI system 146 may indicate that <menu item #1> (e.g., chicken sandwich) is not available and suggest alternatives, such as <menu item #2> (e.g., chicken fingers) and <menu item #3> (e.g., chicken nuggets).

An application programming interface (API) is used to provide a way to interface and synchronize the menu item database 154 with the conversational AI system 146. For example, the API 344 enables a menu in a POS to be synchronized with the menu item database 154, and to use reverse mappings (via the reverse menu mapper 336). The POS parsers 318 are capable of converting the menu from a POS into menu items 316 that are stored in the menu item database 154. The forward mapper 328 converts a menu from a POS to a menu that can be used with the conversational AI system 146, including voice menu features and translations of the voice menu into multiple languages (e.g., Spanish, French, and the like). The reverse mapper 332 converts the menu in the menu item database 154 to a POS format. For example, after an order has been completed, the reverse mapper 332 maps the menu items in the order into a format that the POS can understand to enable the customer to pay for the order (e.g., the employee uses the POS to process payment for the order).

The automatic tag generator 302 is a machine learning based algorithm that generates one or more voice tags for each menu item. The voice tags represent the different ways customers verbally (e.g., often colloquially) identify a menu item during order flow (e.g., when an order is being taken). The automatic tag generator 302 may also lemmatize the tags. Lemmatization groups together the inflected forms of a word so that the group of words can be analyzed as a single item, identified by the word's lemma (e.g., dictionary form). The machine learning algorithm used by the automatic tag generator 302 generates voice tags for a menu item based on the previously gathered conversation data 136. For example, the voice tags for a can of Coke® may include (1) voice tags associated with the menu item, such as “Coke®”, “Coke® can”, “Coca Cola®”, “Coke® drink”, and the like, (2) voice tags associated with competing or similar products, such as “Pepsi®”, “Pepsi® cola”, “Dr. Pepper®”, and the like, and (3) voice tags associated with generic terms for the menu item, such as “cola”, “caffeinated soda”, or the like.

The menu validator 322 validates a pronunciation of the items 316 in the menu item database 154 from an audio perspective, e.g., how the items 316 sound in a conversation when pronounced by the text-to-speech (TTS) module 228 of FIG. 2, and enables an employee of the restaurant to adjust a pronunciation of the menu items 316 to sound natural (e.g., as spoken by a human). For example, the employee can specify that the word “noir” is pronounced as “new-are” (e.g., with a “w” sound after the “n”). This feature also enables regional pronunciations to be put in place. For example, the “pecan” in “pecan pie” may be pronounced as “pea-can” in some geographic regions and as “puh-con” in other geographic regions.

The mapping database 152 is organized such that each table has a primary key and all tables are connected through secondary keys. The primary key is stored in tables in the menu item database 154 while secondary keys are stored in tables in the mapping database 152 that are created using the data provided by the Menu Manager 148. Thus, a menu item, such as “Coke” may have 2 separate customizations. The first customization may be a size customization, e.g., small, medium, or large while the second customization may be regular or diet. The mapping database 152 maps these values from the Menu Manager 148 to the menu item database 154.

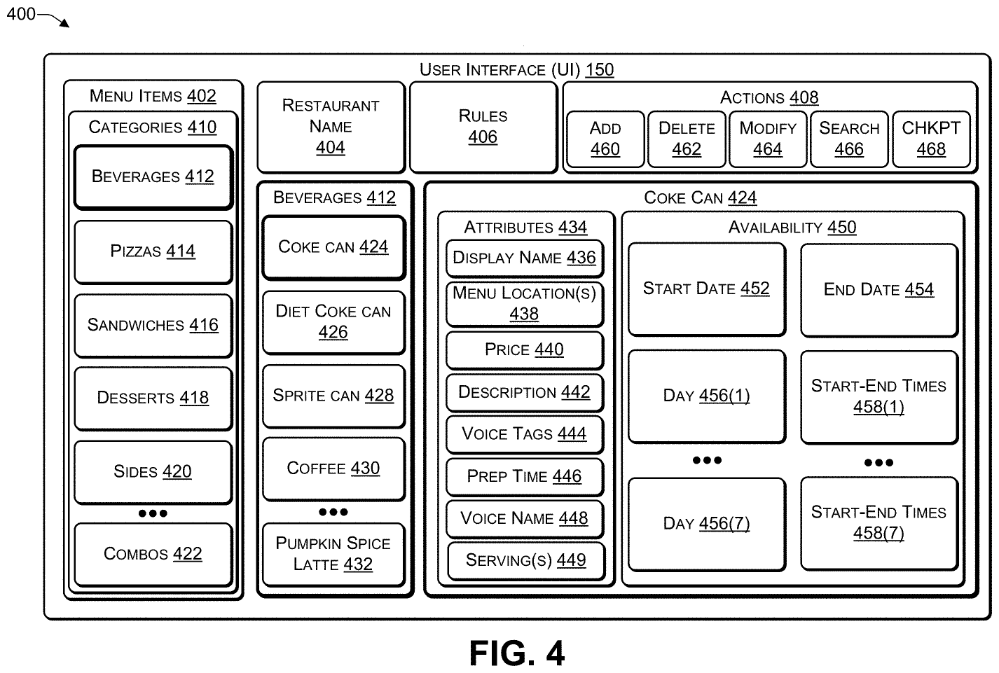

FIG. 4 is a block diagram 400 of an exemplary user interface (UI), according to some embodiments. The UI 150 may include submenus for menu items 402, a restaurant named 404, rules 406, and actions 408. The menu items 402 may be classified into multiple categories for 10, such as beverages 412, pizzas 414, sandwiches 416, desserts 418, sides 420, and combo meals 422. Of course, these are purely provided for illustration purposes and are not to be construed as limiting in any way.

Selecting the beverages 412 category may open up a submenu identifying the available beverages, such as a Coke can 424, a Diet Coke and 426, a sprite can 428, a coffee 430, and a pumpkin spice latte 432. Selecting Coke can 424 may cause the UI 150 to display an additional submenu that includes attributes 434 and availability 450 associated with the Coke can 424.

The attributes 434 may include a display name 436 (e.g., the name the POS displays), menu locations 438 (e.g., the coke can 424 may be displayed in multiple menu locations, including beverages 412, included in the combos 422, as an add-on to a meal, or the like), a price 440, a description 442, one or more voice tags 444, a prep time 446, and a voice name 448 (e.g., pronunciation). The prep time 446 may reflect how long it takes to prepare a menu item. In the case of the Coke can 424, the prep time 446 may be zero while the prep time 446 for a pizza or a sandwich may be several minutes. The pronunciation 448 may enable an employee to adjust how the conversational AI system (e.g., the software agents that interact with customers to take an order) pronounces “Coke can” to account for local pronunciation variations from one geographic region to another. For example, the voice name 448 may be varied to account for a southern accent, a Midwest accent, a Texas drawl, and the like.

The availability 450 enables an employee to indicate when particular menu items are available and when they are unavailable. For example, the availability 450 may include a start date 452 and an end date 454 to specify seasonal or other types of promotional dates during which a particular menu item is available. To illustrate, the pumpkin spice latte 432 may be available several weeks prior to Halloween and one or two weeks after Halloween and may be unavailable the rest of the year. As another example, the restaurant may put together a celebrity endorsed meal or combo that is available for a limited period of time. The availability 450 may include the seven days of the week 456(1) to 456(7) and a start and an end time 458(1) to 458(7) associated with each day of the week. For example, some breakfast menu items may be available on weekday mornings (e.g., from 6 AM to 11 AM), but may be available all day (e.g., from 6 AM to 11 PM) on weekends.

The actions 408 may include enabling an employee to add 460 a menu item, delete 462 a menu item, modify 464 a menu item, and perform a search 466. For example, the employee can use the UI 150 to add a particular menu item, such as the pumpkin spice latte 432, as a new item when is initially introduced. The employee can use the UI 150 to modify 464 the availability 450 of a menu item, such as the pumpkin spice latte 432. For example, if the popularity of the particular menu item grows, the restaurant may modify the availability 450 and offer the particular menu item (e.g., pumpkin spice latte 432) all winter long or even all year round. If the popularity of the particular menu item (e.g., pumpkin spice latte 432) wanes, then the restaurant may reduce the availability 450 of the item or may delete the item from the menu entirely. The employee can use the search 466 to search for “pumpkin spice latte” instead of navigating multiple menus and sub-menus.

The UI 150 enables the voice name 448 (e.g., pronunciation) to be added as a separate voice name for each of the menu items 402 to enable each menu item to be used in a conversation between the conversational AI and a customer, instead of using the display name 436 or an item name stored in the POS. For example, the POS may store an item as “Can Coke” but in conversation the conversational AI uses “Coke”.

The UI 150 enables a separate display name 436 to be associated with each of the menu items 402. The display name 436 is a written representation of each menu item, e.g., how each menu item is displayed by each POS, how each menu item is displayed on the electronic and/or printed order summary (e.g., receipt), and the like. Thus, the display name 436 is the written form of each menu item displayed for human employees that are operating the POS.

The rules 406 include menu editing rules. For example, a rule can be created to apply to all menu items 402 or a particular subset of the menu items 402, such as a rule for beverages 412, a rule for pizzas 414, and so on. For example, most menu items 402 have some type of customization, such as size, flavor, condiments (e.g., ketchup, mustard, relish, pickle, and the like), and so on. For a pizza, the customization may include the toppings selected for a pizza. The UI 150 enables a rule to be created to refer to pizza customizations as “toppings”, both as the display name 436 and the voice name 448 (e.g., the pronunciation used by the AI system/software agents).

The UI 150 enables the employee create items that are not displayed on the menu by not specifying a menu location using the menu locations 438. For example, restaurants often change their menu and remove less popular menu items. However, some regular customers may continue to order an item that was removed from the menu. The UI 150 enables such items to be removed from the menu while making them available for ordering. The conversational AI system is able to recognize and add such items (e.g., that are not displayed on the menu) to an order.

The UI 150 may provide additional actions in the actions 408, such as the ability to generate, maintain, change, deploy, and test the dialog flow for the menu items 402 in a conversational flow to provide conversation-based ordering.

The UI 150, via the actions 408, may enable an employee to create a checkpoint (CHKPT) 468. For example, before making changes to the menu, the employee may create a checkpoint using the checkpoint 468. If the employee makes an error while changing the menu, the menu can be rolled back to the to the previous (e.g., checkpointed) version of the menu. In some cases, the checkpoint may be automatically created by the UI 150 prior to an add, delete, or modify action being performed.

The prep time 446 enables the restaurant to specify the time to prepare each menu item, enabling the restaurant to determine the total preparation time for each order and notify the customer (e.g., “Your order will be ready in approximately 10 minutes.”).

The UI 150 may enable the employee to specify a number of servings 449 for each menu item. For example, if a customer asks “How many people does a basket of fries serve?”, the conversational AI system can indicate that the basket of fries serves 2 to 3 adults. If a customer asks “How many people does an extra-large pizza serve?”, the conversational AI system can indicate that the extra-large pizza serves 4 to 5 adults.

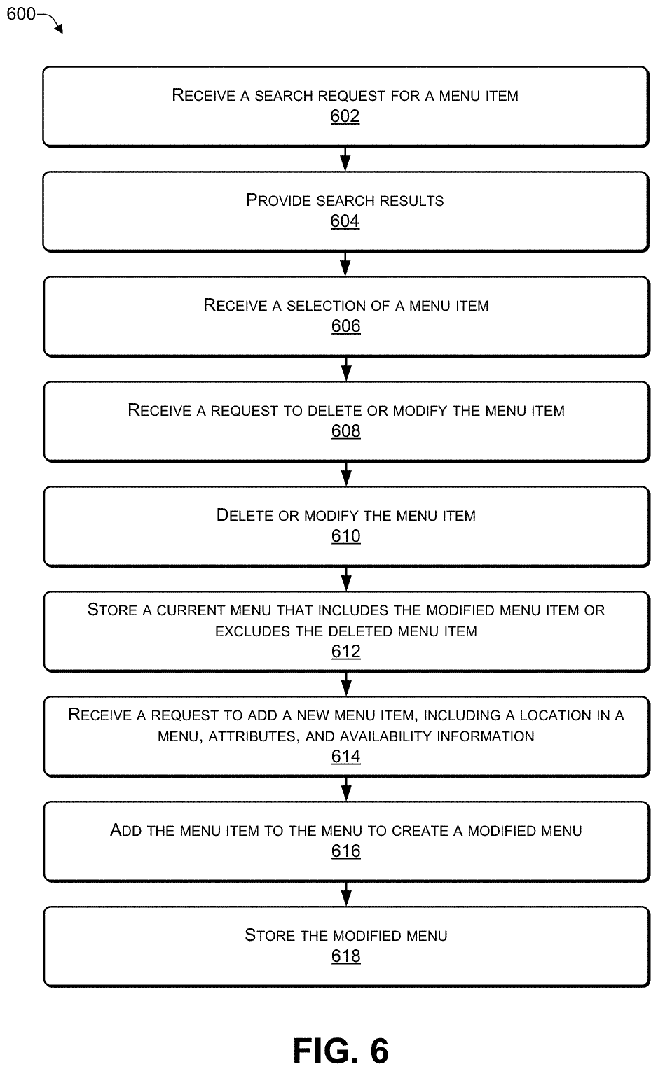

In the flow diagrams of FIGS. 5 and 6, each block represents one or more operations that can be implemented in hardware, software, or a combination thereof. In the context of software, the blocks represent computer-executable instructions that, when executed by one or more processors, cause the processors to perform the recited operations. Generally, computer-executable instructions include routines, programs, objects, modules, components, data structures, and the like that perform particular functions or implement particular abstract data types. The order in which the blocks are described is not intended to be construed as a limitation, and any number of the described operations can be combined in any order and/or in parallel to implement the processes. For discussion purposes, the processes 500 and 600 are described with reference to FIGS. 1, 2, 3, and 4 as described above, although other models, frameworks, systems and environments may be used to implement this process.

FIG. 5 is a flowchart of a process 500 that includes automatically generating a mapping database, according to some embodiments. The process 500 may be performed by one or more components executed by the server 106, as illustrated in FIG. 3.

At 502, the process may receive (or retrieve) a menu from a point-of-sale (POS) terminal. For example, in FIG. 3, the menus 140 may be received or retrieved from one or more POS devices, such as the POS 102 of FIG. 1.

At 504, the process may parse the menu to create a parsed menu. At 506, the process may automatically convert the parsed menu into a format suitable for AI engines to use. For example, in FIG. 3, the POS parsers 318 may use the POS data 314 to process each menu 140 based on the type of POS in which each menu 140 was stored. For example, the POS parser 318(1) may be used to parse the menu 140(1) stored (e.g., in a first format) in a first vendor's POS and the POS parser 318(N) may be used to parse the menu 140(N) stored (e.g., in an Nth format) in an Nth vendor's POS. The parsed menu 319 may be used to create the menu item database 154 (e.g., formatted menu) that includes the items 316 stored in a format suitable for the conversational AI system 146 to use.

At 508, the process may perform a comparison of the parsed menu and the formatted menu. At 510, the process may modify the formatted menu based on the comparison if there are differences between the parsed menu and the formatted menu. For example, in FIG. 3, the forward mapper 328 and the reverse mapper 332 may use the forward mapping rules 330 and the reverse mapping rules 334, respectively, to compare the parsed menu 319 with the items 316 in the menu item database 154 (e.g., the formatted menu).

At 512, the process may create a menu mapping for the formatted menu, including for example, a mapping of pricing, menu item pronunciation, voice tags, and the like. At 514, the process may validate the menu mapping. At 516, the process may automatically create a mapping database. For example, in FIG. 3, the process may use the menu mapper 140 to create the mapping database 152. The mapping database 152 maps combo meals and menu items into individual menu items. For example, a large vegetarian pizza may be mapped to a large cheese pizza with up to four vegetarian toppings. The menu validator 322 may be used to validate the menu item database including validating a price and validating a dialog (e.g., pronunciation) of each of the menu items 316.

At 518, the process may deploy the formatted menu and the mapping database for use with the AI engines. For example, in FIG. 3, the menu item database 154 including the menu items 316 along with the synchronization manager 338 may be deployed for use with the conversational AI system 146 to enable the conversational AI system 146 to analyze customer utterances and create an order based on the utterances.

FIG. 6 is a flowchart of a process 600 that includes storing a modified menu, according to some embodiments. The process 600 may be performed by the UI 150 of FIG. 1 and FIG. 4.

At 602, the process may receive a search request for a menu item. At 604, the process may provide search results after performing the search based on the search request. At 606, the process may receive a selection of a menu item. For example, in FIG. 4, the UI 150 may receive a search request that includes a selection of the search 466 and at least a partial spelling of one of the menu items 402. In response, the UI 150 may perform a search of the menu items 402 based on the search request and provide search results that includes zero or more of the menu items 402.

At 608, the process may receive a request to modify or delete the menu item. At 610, the process may modify or delete the menu item based on the request. At 612, the process may store the current menu that includes the modified menu item or excludes the deleted menu item. For example, in FIG. 3, the UI 150 may receive a request to modify 464 or delete 462 one of the menu items 402. The request to modify 464 or delete 462 may be made by selecting one of the menu items 402 either from the search results provided by the search 466 or by going through the menus and submenus of the menu items 402. The UI 150 may modify or delete the selected menu item to create a modified menu and store the modified menu that includes the modified menu item or excludes the deleted menu item.

At 614, the process may receive a request to add a new menu item including a location in the menu, attributes of the new menu item, and availability information. At 616, the process may add the menu item to the menu to create a modified menu at 618, the process may store the modified menu. For example, in FIG. 3, the UI 150 may receive, via the add 460 command, a request to add a new menu item to the menu items 402. The request to add the new menu item may include the attributes 434 and the availability 450 associated with the new menu item. The UI 150 may store the menu that includes the new menu item.

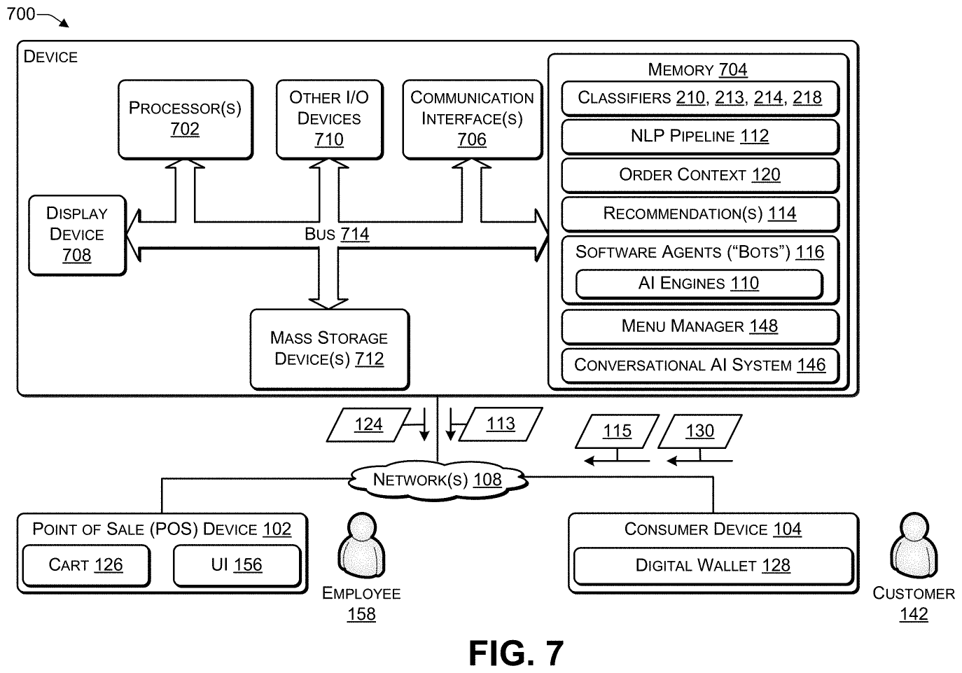

FIG. 7 illustrates an example configuration of a device 700 that can be used to implement the systems and techniques described herein, such as, for example, the customer device 104 and/or the server 106 of FIG. 1. For illustration purposes, the device 700 is illustrated in FIG. 7 as implementing the server 106 of FIG. 1.

The device 700 may include one or more processors 702 (e.g., CPU, GPU, or the like), a memory 704, communication interfaces 706, a display device 708, other input/output (I/O) devices 710 (e.g., keyboard, trackball, and the like), and one or more mass storage devices 712 (e.g., disk drive, solid state disk drive, or the like), configured to communicate with each other, such as via one or more system buses 714 or other suitable connections. While a single system bus 714 is illustrated for ease of understanding, it should be understood that the system buses 714 may include multiple buses, such as a memory device bus, a storage device bus (e.g., serial ATA (SATA) and the like), data buses (e.g., universal serial bus (USB) and the like), video signal buses (e.g., ThunderBolt®, DVI, HDMI, and the like), power buses, etc.

The processors 702 are one or more hardware devices that may include a single processing unit or a number of processing units, all of which may include single or multiple computing units or multiple cores. The processors 702 may include a graphics processing unit (GPU) that is integrated into the CPU or the GPU may be a separate processor device from the CPU. The processors 702 may be implemented as one or more microprocessors, microcomputers, microcontrollers, digital signal processors, central processing units, graphics processing units, state machines, logic circuitries, and/or any devices that manipulate signals based on operational instructions. Among other capabilities, the processors 702 may be configured to fetch and execute computer-readable instructions stored in the memory 704, mass storage devices 712, or other computer-readable media.

Memory 704 and mass storage devices 712 are examples of computer storage media (e.g., memory storage devices) for storing instructions that can be executed by the processors 702 to perform the various functions described herein. For example, memory 704 may include both volatile memory and non-volatile memory (e.g., RAM, ROM, or the like) devices. Further, mass storage devices 712 may include hard disk drives, solid-state drives, removable media, including external and removable drives, memory cards, flash memory, floppy disks, optical disks (e.g., CD, DVD), a storage array, a network attached storage, a storage area network, or the like. Both memory 704 and mass storage devices 712 may be collectively referred to as memory or computer storage media herein and may be any type of non-transitory media capable of storing computer-readable, processor-executable program instructions as computer program code that can be executed by the processors 702 as a particular machine configured for carrying out the operations and functions described in the implementations herein.

The device 700 may include one or more communication interfaces 706 for exchanging data via the network 108. The communication interfaces 706 can facilitate communications within a wide variety of networks and protocol types, including wired networks (e.g., Ethernet, DOCSIS, DSL, Fiber, USB etc.) and wireless networks (e.g., WLAN, GSM, CDMA, 802.11, Bluetooth, Wireless USB, ZigBee, cellular, satellite, etc.), the Internet and the like. Communication interfaces 706 can also provide communication with external storage, such as a storage array, network attached storage, storage area network, cloud storage, or the like.

The display device 708 may be used for displaying content (e.g., information and images) to users. Other I/O devices 710 may be devices that receive various inputs from a user and provide various outputs to the user, and may include a keyboard, a touchpad, a mouse, a printer, audio input/output devices, and so forth.

The computer storage media, such as memory 704 and mass storage devices 712, may be used to store software and data, including, for example, the classifiers 210, 213, 214, 218, the NLP pipeline 112, the order context 120, the recommendations 114, the software agents 116, the menu manager 148, and the conversational AI system 146.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. A method comprising:
receiving, by a menu manager executing on a server, a menu having a particular format from a point-of-sale (POS) terminal;
parsing, by the menu manager, the menu to create a parsed menu, the menu parsed using POS data indicating a formatting of the menu;
automatically converting, by the menu manager, the parsed menu into multiple menu items;
storing, by the menu manager, the multiple menu items in a menu item database;
creating, by the menu manager, a mapping database that includes pricing data, pronunciation data, and voice tags associated with individual menu items of the multiple menu items;
providing one or more software agents access to the mapping database; and
instructing an individual software agent of the one or more software agents to initiate a conversation with a customer to receive a voice-based order, the individual software agent comprising an instance of an artificial intelligence engine.

2. The method of claim 1, further comprising:
receiving a customer utterance from the customer; and
determining, using the artificial intelligence engine, a customer intent based on the customer utterance;
predicting, using the artificial intelligence engine, a menu item of the multiple menu items; and
adding the menu item to an order associated with the customer.

3. The method of claim 1, further comprising:
displaying a user interface to enable a user to modify the menu item database, wherein the user interface automatically creates a checkpoint by storing a copy of the menu item database prior to the menu item database being modified, the checkpoint enabling the copy of the menu item database to be restored in response to determining that an error occurred after modifying the menu item database.

4. The method of claim 3, wherein the user interface comprises:
a search function to search for a particular menu item in the menu item database.

5. The method of claim 3, wherein the user interface comprises an add interface element to:
add a new menu item to the menu;
add one or more attributes associated with the new menu item; and
add an availability of the new menu item.

6. The method of claim 5, wherein the one or more attributes of the new menu item comprise:
a display name associated with the new menu item for display by the point-of-sale terminal;
a price associated with the new menu item;
a description of the new menu item;
one or more voice tags associated with the new menu item, each voice tag of the one or more voice tags identifying a vocalized word or phrase used to reference the new menu item;
a preparation time to prepare the new menu item;
an approximation of a number of people estimated to be served by the new menu item; or
any combination thereof.

7. The method of claim 5, wherein the availability of the new menu item comprises:
a start date indicating when the new menu item is available for ordering;
an end date after which the new menu item is unavailable for ordering;
a start time of day when the new menu item is available for ordering;
an end time of day after which the new menu item is unavailable for ordering; or
any combination thereof.

8. A server comprising:
one or more processors; and
one or more non-transitory computer readable media storing instructions executable by the one or more processors to perform operations comprising:
receiving, by a menu manager executing on the server, a menu having a first format from a point-of-sale (POS) terminal;
parsing, by the menu manager, the menu to create a parsed menu, the menu parsed using POS data indicating a formatting of the menu;
automatically converting, by the menu manager, the parsed menu into multiple menu items;
storing, by the menu manager, the multiple menu items in a menu item database;
creating, by the menu manager, a mapping database that includes pricing data, pronunciation data, and voice tags associated with individual menu items of the multiple menu items;
providing multiple software agents access to the mapping database; and
instructing an individual software agent of the one or more software agents to initiate a conversation with a customer to receive a voice-based order, the individual software agent comprising an instance of an artificial intelligence engine.

9. The server of claim 8, the operations further comprising:
receiving a second menu having a second format from a second point-of-sale (POS) terminal, the second format different from the first format;
parsing the second menu to create a second parsed menu, the second menu parsed using second POS data indicating a second formatting of the second menu;
automatically converting the second parsed menu into additional menu items;
storing the additional menu items in the menu item database;
adding to the mapping database second pricing data, second pronunciation data, and second voice tags associated with individual ones of the additional menu items; and
providing additional software agents access to the mapping database.

10. The server of claim 8, wherein the user interface comprises:
displaying, at the point-of-sale terminal, a user interface to enable a user to modify the menu item database, wherein the user interface automatically creates a checkpoint by storing a copy of the menu item database prior to the menu item database being modified, the checkpoint enabling the copy of the menu item database to be restored in response to determining that a modification of the menu item database includes an error; and
wherein the user interface includes a search function to search for a particular menu item in the menu item database.

11. The server of claim 10, wherein the user interface comprises a modify interface element to:
modify a particular menu item currently in the menu;
modify one or more attributes associated with the particular menu item;
modify an availability of the particular menu item; or
any combination thereof.

12. The server of claim 11, wherein the attributes of the particular menu item comprise:
a display name associated with the new menu item for display by the point-of-sale terminal;
a price associated with the new menu item;
a description of the new menu item;
one or more voice tags associated with the new menu item, each voice tag of the one or more voice tags identifying a vocalized word or phrase used to reference the new menu item;
a preparation time to prepare the new menu item;
an approximation of a number of people estimated to be served by the new menu item; or
any combination thereof.

13. The server of claim 11, wherein the availability of the particular menu item comprises:
a start date when the particular menu item is available for ordering; and
an end date after which the particular menu item is unavailable for ordering.

14. The server of claim 11, wherein the availability of the particular menu item comprises:
a start time of day when the particular menu item is available for ordering; and
an end time of day after which the particular menu item is unavailable for ordering.

15. A memory device to store instructions executable by one or more processors to perform operations comprising:
receiving, by a menu manager executing on a server, a menu having a particular format from a of point-of-sale (POS) terminal;
parsing, by the menu manager, the menu to create a parsed menu, the menu parsed using POS data indicating a formatting of the menu;
automatically converting, by the menu manager, the parsed menu into multiple menu items;
storing, by the menu manager, the multiple menu items in a menu item database;
creating, by the menu manager, a mapping database that includes pricing data, pronunciation data, and voice tags associated with individual menu items of the multiple menu items;
providing multiple software agents access to the mapping database; and
instructing an individual software agent of the one or more software agents to initiate a conversation with a customer to receive a voice-based order, the individual software agent comprising an instance of an artificial intelligence engine.

16. The memory device of claim 15, further comprising:
providing a user interface to enable a user to modify the menu item database, wherein the user interface automatically creates a checkpoint by storing a copy of the menu item database prior to the menu item database being modified, the checkpoint enabling the copy of the menu item database to be restored in response to determining that an error occurred after modifying the menu item database.

17. The memory device of claim 16, wherein the user interface comprises:
a search function to search for a particular menu item in the menu item database.

18. The memory device of claim 15, wherein the user interface comprises an add interface element to:
add a new menu item to the menu;
add one or more attributes associated with the new menu item; and
add an availability of the new menu item.

19. The memory device of claim 15, wherein the one or more attributes of the new menu item comprise:
a display name associated with the new menu item for display by the point-of-sale terminal;
a price associated with the new menu item;
a description of the new menu item;
one or more voice tags associated with the new menu item, each voice tag of the one or more voice tags identifying a vocalized word or phrase used to reference the new menu item;
a preparation time to prepare the new menu item;
an approximation of a number of people estimated to be served by the new menu item; or
any combination thereof.

20. The memory device of claim 15, wherein the availability of the new menu item comprises:
a start date indicating when the new menu item is available for ordering;
an end date after which the new menu item is unavailable for ordering;
a start time of day, for each day of the week, when the new menu item is available for ordering;
an end time of day, for each day of the week, after which the new menu item is unavailable for ordering; or
any combination thereof.
